(19) United States
(12) Patent Application Publication
(10) Pub. No.: US 2023/0136637 A1
(43) Pub. Date: May 4, 2023

(54) POP-UP ROOF FOR MULTIPURPOSE VEHICLES

(71) Applicant: LCI ITALY S.R.L., San Casciano in Val di pesa (Florence) (IT)

(72) Inventors: Luigi GOZZI, San Casciano in Val di Pesa (Florence) (IT); Paolo BERNARDESCHI, San Casciano in Val di Pesa (Florence) (IT); Riccardo MINUTI, San Casciano in Val di Pesa (Florence) (IT)

(21) Appl. No.: 17/912,071

(22) PCT Filed: Feb. 25, 2021
(86) PCT No.: PCT/IB2021/051571

§ 371 Date: Sep. 16, 2022

(30) Foreign Application Priority Data
Mar. 16, 2020 (IT) 102020000005581

(51) Int. Cl. B60P 3/34; B60J 7/16; B60H 1/00; B60H 1/24

(52) U.S. Cl. CPC B60P 3/343; B60J 7/1657; B60H 1/00564; B60H 1/247

(57) ABSTRACT

A pop-up roof, for multi-purpose vehicles such as camper vans and similar, includes components for increasing the climatic comfort of the additional interior compartment of the vehicle when the rigid top of the pop-up roof is in a raised operating position. A fixed frame following the shape of the opening of the vehicle roof includes a hollow structure defining an air duct with annular development. At least one air inlet in the duct connects with an air supply channel of the air conditioning system provided in the vehicle and a plurality of air diffusion vents distributed along the air duct, sending air towards the additional internal compartment.

### TECHNICAL SECTOR

The present invention relates to the technical field concerning multi-purpose vehicles equipped for recreational use such as camping and the like.

The type of vehicles referred to herein are in particular motor homes, vans and the like, which are preferably mounted on a light commercial vehicle, i.e. those that can be driven with a standard car license.

### STATE OF THE ART

The term camper, as commonly known, is also generically attributed to types of camping vehicles that should actually be called by different names.

In this respect, motor caravans are those which retain only the front part of the original bodywork of a commercial van, up to and including the driver's cab (so-called ‘unroofed’), while the living quarters are made of a type of panel construction similar to that of towing caravans.

Motorhomes, on the other hand, are vehicles in which all or almost all of the bodywork is built from scratch on a bare chassis with only the mechanical parts and the steering components, including the steering wheel.

Finally, campers in the strictest sense of the world are camping vehicles in which the original bodywork of a commercial van or van derivative is almost entirely preserved, with the addition of accessories such as special windows, ventilation grills, service hatches and other components, as well as suitable interior fittings.

In the range of all manufacturers of commercial vans today, there are ‘low’ and ‘high’ versions of the same model. The main difference lies in the fact that in the low models you either cannot stand upright in the load compartment or, in the best case, you are almost touching the ceiling without any kind of floor or ceiling covering, whereas in the high models you can stand comfortably with sufficient headroom.

Obviously, low vehicles offer better aerodynamics than high ones, hence lower consumption especially at motorway speeds; naturally, a lower load volume must be considered adequate.

One particular type of camper (or van), which harks back to a tradition dating back to the 1960s, involves the use of “low” vans to which a raised roof is fitted, which is only deployed during stopovers, when greater height is actually needed in the middle and rear, where the living area is located.

Without delving too much into the constructional details of the various models of elevating roof, each of them is substantially formed by: a fixed frame, made integral with the edge of the opening made at the top of the roof; a lever mechanism for moving a rigid cover between an inoperative lowered travel position, substantially matching said fixed frame and vehicle's roof, and a raised operative position, configurable in a stationary condition; foldable closing means, usually of the tent type in technical fabric, extendable as a result of said raised operative position of the rigid cover, suitable for laterally plugging the opening created between the latter and said roof

Nowadays, in view of the general increase in size that has affected all types of road vehicles, including the above-mentioned vans and minibuses, the application of a pop-up roof no longer derives solely from the need to gain height to stand up in the passenger compartment. Besides, the application of a pop-up roof allows the additional compartment to be used to create a mansard “sleeping area”, with a bed or bunk that can be reached from the passenger compartment below using a ladder. This updated intended use can apply to both the ‘low’ and ‘high’ versions of these vans, naturally with constructional differences.

The main difference is that in the “low” versions the roof of the van is cut around the perimeter of the pop-up roof to be fitted. Additionally, the bed is secured to the pop-up roof by means of suitable suspension devices that hold it against the pop-up roof when it is lowered and lower said bed so that it can be used when the pop-up roof is raised. In the “high” versions, on the other hand, the bed can be placed directly on the roof of the van and an opening smaller than the roof of the van can be made, just to create the passage for getting in and out of the passenger compartment and towards it.

The commonly reported drawback in these vehicles equipped with a pop-up roof is the poor climatic comfort found in the additional volume provided by the lifting of the rigid top. In fact, in these circumstances, the hot air in the passenger compartment concentrates and stagnates in hot weather, whereas a large dispersion of heat occurs in cold weather, due to the poor thermal insulation offered by both the hard top and the side curtain.

Obviously, this discomfort is much more noticeable today than in pioneering times, since modern users are used to vehicles, even commercial ones, being effectively air-conditioned from the outset, in all seasons and weather conditions.

In addition, this discomfort is amplified by the presence of a bed that obstructs a large part of the passage between the passenger compartment and the mansard area created by the raised roof, in which the vehicle's air conditioning can arrive in insufficient proportions to guarantee a minimum level of comfort for the occupants.

### SUMMARY OF THE INVENTION

Scope of the present invention is therefore to propose a pop-up roof for multi-purpose vehicles, which has such constructional features as to be able to achieve, in the additional volume offered during stops, a climatic comfort which is significantly better than what can be obtained with pop-up roofs of known technique.

A further scope of the invention is to connect the pop-up roof to at least one of the air ducts of the original air conditioning system of the vehicle, in order to have air conditioning or ventilation air to be distributed in the under-roof volume. Accordingly, the parameters of the air present in the under-roof volume with respect to those of the other parts of the passenger compartment are substantially equalized.

A further scope of the invention is to realize the parts constituting the present pop-up roof with materials which are light, robust, unalterable in time and resistant both to sunlight and to atmospheric agents.

A further scope of the invention is to provide the pop-up roof with layers of heat insulating material that contribute to reduce the heat exchange with the outside of the components of the pop-up roof.

Yet, another scope of the invention relates to the intent of realizing a pop-up roof that, when placed in a lowered travelling position, is aerodynamically efficient both with regard to the resistance to the advancement of the vehicle and to avoid the occurrence of noise such as whistling or hissing at higher speeds.

These and other purposes are fully achieved by means of a pop-up roof for multipurpose vehicles, of the type comprising a fixed frame associated above the vehicle's roof of one of said vehicles and provided with a lever mechanism for moving a rigid top between an inoperative lowered travel position, substantially in line with said vehicle's roof, and a raised operational position, configurable in the parking condition of the same multipurpose vehicle, designed to increase the internal useful height of the latter in the central-rear area, with said roof also equipped with flexible screen means, extended as a consequence of said raised operating position of the rigid top, suitable for sideway screening the opening created between the latter and said vehicle's roof.

The elevating roof provides means for increasing the climatic comfort of the additional interior compartment of said vehicle obtained with said elevated operating position of the rigid top, with said means comprising:
said fixed frame applied above said vehicle's roof, so as to edge an opening made in the latter, with the same fixed frame consisting of a hollow structure, defining an annular air duct;
at least one air inlet, provided in said air duct, for the connection of the latter with at least an air supply channel of the air conditioning system of said vehicle;
a plurality of air diffusion vents, distributed along said air duct in the fixed frame, provided for distributing air to said additional compartment under the aforementioned rigid top.

### BRIEF DESCRIPTION OF THE DRAWINGS

The features of the invention will be clear from the following description of a preferred embodiment of the pop-up roof for multi-purpose vehicles of the subject matter, in accordance with the claims and with the aid of the appended drawing plates, wherein:

FIG. 1 shows a schematic side view of a multi-purpose vehicle equipped with this elevating roof;

FIG. 2 shows a three-quarter front view of the vehicle with the pop-up roof in the raised operating position;

FIG. 3 shows a schematic view from above of the fixed frame of the elevating roof;

FIG. 3A illustrates, in magnified scale and with sectioned parts, detail A of the fixed frame of FIG. 3;

FIG. 3B illustrates, in magnified scale and with sectioned parts, detail B of the fixed frame of FIG. 3;

FIG. 4 illustrates schematically, in section, the shell section of the rigid cover of the elevating roof;

FIG. 5A illustrates, in a view similar to FIG. 1, a van with a low roof provided with a pop-up roof bearing a bed associated with it, with the pop-up roof in the raised operating position and the bed still resting against the same roof;

FIG. 5B illustrates a view of the van of FIG. 5A, with the bed suspended from the pop-up roof, lowered to the operating position;

FIG. 6A illustrates, in a view similar to the preceding ones, a van with a high roof provided with a pop-up roof, arranged in an inoperative lowered position, leaning against a bed supported by the original roof of the vehicle;

FIG. 6B illustrates a view of the van of FIG. 6A, with the pop-up roof in the raised operational position to make the bed accessible and habitable.

### DETAILED DESCRIPTION OF THE PREFERRED EMBODIMENTS

In the above figures, the pop-up roof, object of the present invention, is globally indicated by reference 1.

The pop-up roof 1 is intended to be mounted, either originally or, more frequently, as an aftermarket accessory, on a light commercial vehicle equipped as a motorhome, van or similar, thereby transforming it into a multi-purpose vehicle V, equipped for recreational use such as camping.

Said multi-purpose vehicle V is usually, albeit not necessarily, among those that can be driven with a normal driving license.

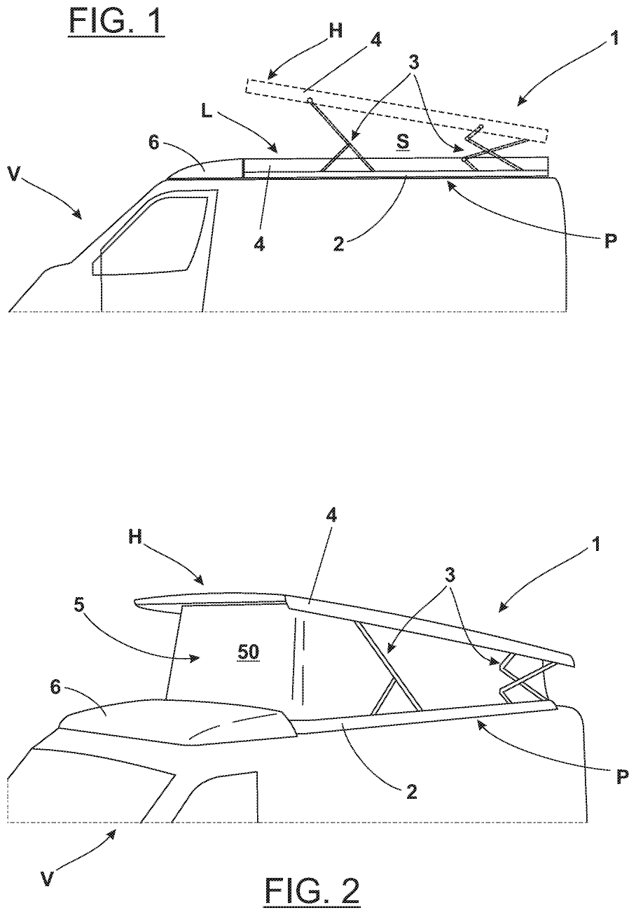

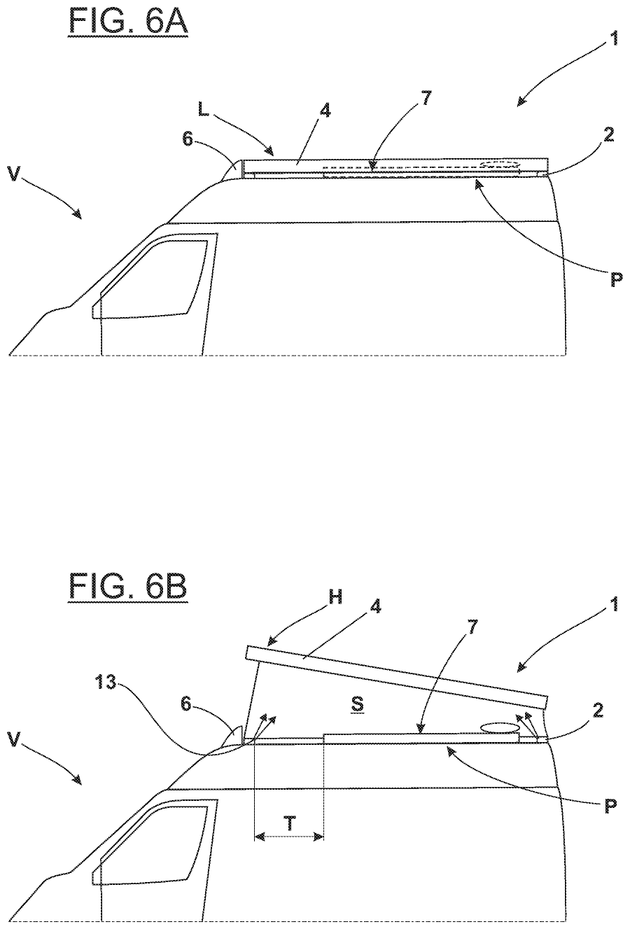

Such commercial vehicles are proposed, by the respective manufacturers, with either a low roof P (FIGS. 1, 2, 5A, 5B) or a high roof (FIGS. 6A, 6B). In the former, the internal height of the rear compartment may already allow the driver to stand upright, although at the limit and for persons of average height, while the latter are, obviously, decidedly more habitable in height.

Compared to the past, where the pop-up roof 1 only served to increase the otherwise insufficient living height, in today's commercial vehicles, in view of the general increase in size that has affected all types of road vehicles, the application of a pop-up roof 1 can advantageously allow the additional internal compartment S to be used to create an attic “sleeping area”, with a bed or bunk 7 that can be reached from the passenger compartment below with a ladder.

The pop-up roof 1, in a well-established manner, comprises a fixed frame 2 associated superiorly to the roof P of one of said vehicles V. Said pop-up roof 1 is provided with a lever mechanism 3 for the movement of a rigid top 4 between an inoperative lowered travel position L, substantially matching said roof P, and an raised operational position H, configurable in a stationary condition of the same multi-purpose vehicle V, provided for increasing the internal useful height of the latter in the central-rear area (FIG. 1).

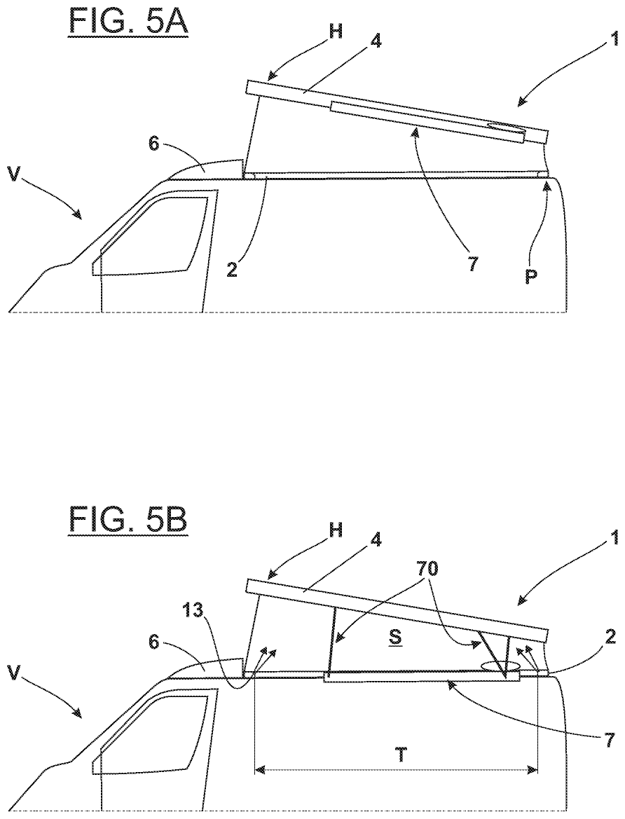

In the case of multi-purpose vehicles V with a low roof, regardless of whether or not said bed 7 is provided in the additional internal compartment S, the roof of the original van is cut out by making an opening T, which follows the entire inside perimeter of the fixed frame 2 of the pop-up roof 1 to be fitted (FIG. 5A, 5B).

If the equipment envisages the bed 7, the bed is associated with the rigid top 4, by means of suitable suspension elements 70, of a known type. Such means are suitable to keep it leaning against the same rigid top 4 when the latter is in the lowered travel position L, as well as to lower it in order to be used after the rigid top 4 is in the said raised operational position H (see again FIGS. 5A, 5B).

On the other hand, in the case of multi-purpose vehicles V with a high roof, it is possible to place the bed 7 directly on the roof of the van and make a smaller opening T just to create the passage from the passenger compartment to/from the aforementioned additional internal compartment S (FIG. 6A, 6B).

In yet another known manner, the pop-up roof 1 is further provided with foldable screen means 5, for example in flexible material 50 such as an awning made of a suitable technical fabric, extended as a result of said raised operational position H of the rigid top 4, suitable for laterally plugging the opening created between the latter and said vehicle's roof P (FIG. 2).

The pop-up roof 1, according to the invention, provides means 10 for increasing the climatic comfort of the additional internal compartment S of said vehicle V obtained with said raised operational position H of the rigid top 4.

Said means 10 include a fixed frame 2 having the form of a frame, like those of known type, applied above said roof P, to circumscribe said opening T made in the latter. However, said fixed frame 2 is constituted, in an innovative way, by a hollow structure 20 internally empty, defining an air duct 11 with annular extension, which follows the shape of said fixed frame 2.

Said hollow structure 20, in a preferred embodiment, comprises the association of at least two elements of thermoformed plastic material.

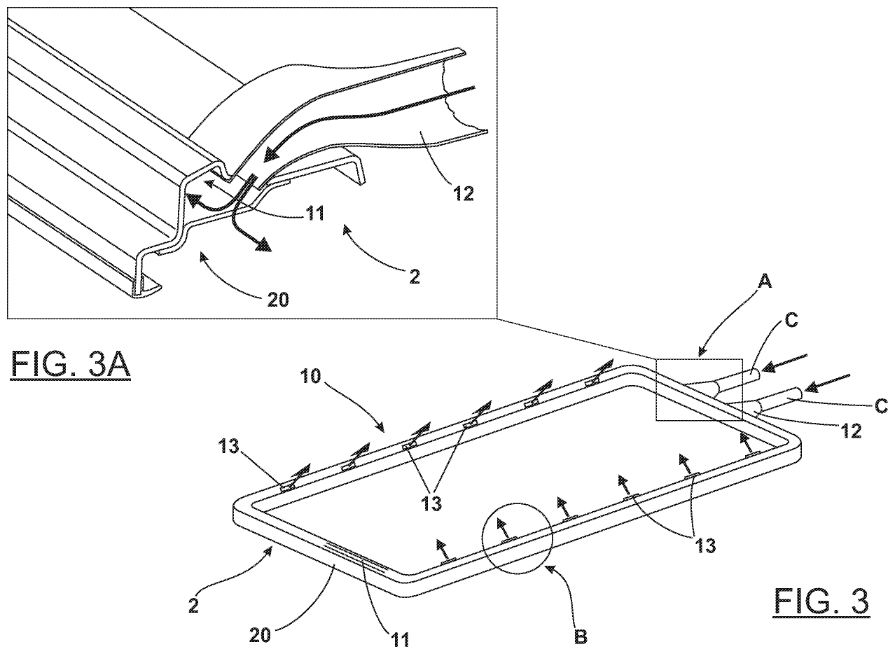

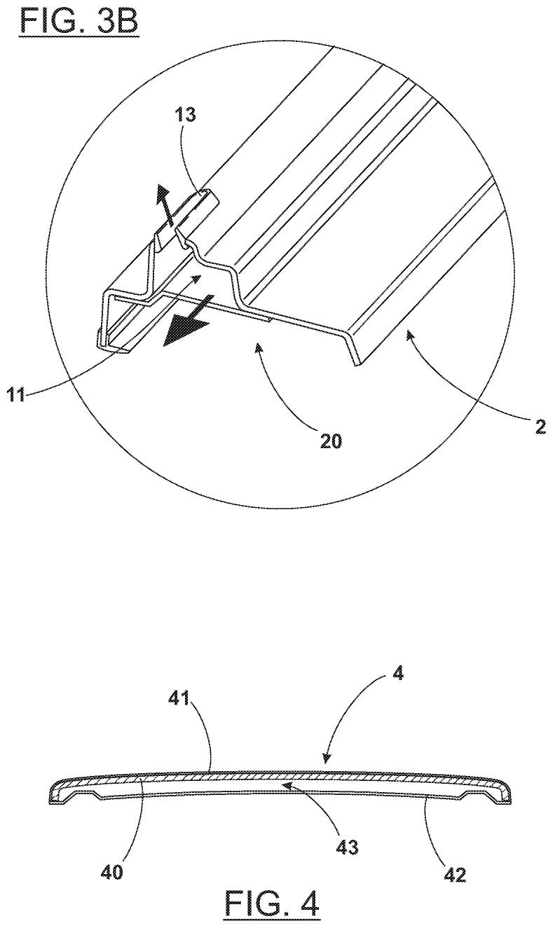

In the aforementioned air duct 11 there is at least one air inlet 12, which allows to connect the same air duct 11 with at least one ventilation or air supply channel C served by the air conditioning system (not illustrated) originally installed in said vehicle V (FIGS. 3 and 3A).

Along the same air duct 11 air diffusion vents 13, in a prefixed order, are distributed, preferably oriented upwards, intended to send ventilation or conditioned air towards the additional internal compartment S below the aforementioned rigid top 4, arranged in a raised operational position H (FIGS. 3, 3B, 5B, 6B).

This makes the occupants of the bed 7 considerably more comfortable, since the bed 7 itself, due to its presence in the condition of use, severely limits the passage area, through said opening T, by which the only air introduced into the underlying passenger compartment could reach the additional compartment S.

In a first embodiment of the pop-up roof 1, the air diffusion vents 13 are closed by the rigid top 4 itself when it is in the inoperative lowered travel position L.

In a second embodiment, the rigid top 4 is instead provided with a series of niches (not illustrated) at the bottom in correspondence with the vents 13, suitably shaped to leave the vents 13 open and to divert the air flow towards the area below the passenger compartment.

Among said means 10 for increasing the climatic comfort of the additional interior compartment S, there shall be provided, individually or in combination:
at least one layer of thermal insulating material 40 coupled to said rigid top 4;
at least one layer of heat insulating material (not illustrated) coupled to said flexible material 50 of the foldable screen means 5.

In the preferred constructive solution of the illustrated example, said rigid top 4 comprises a shell structure, in which the external layer 41 is made of thermoformed plastic material and the internal layer 42 is made of polycarbonate.

Advantageously, the thermoformed plastic material of the aforementioned hollow structure 20 of the fixed frame 2 and that of the external layer 41 of the rigid top 4 is made of a multilayer of ABS and PMMA (polymethylmethacrylate), which provides excellent weather resistance, colour, fastness to the action of the sun and lightness.

The provision of said shell structure for the rigid top 4 enables to obtain, between said external and internal layers, a service spacing 43 for electrical cables and/or for mechanical elements for closing the rigid top 4 and/or for inserting said at least one layer of heat-insulating material 40.

The aforementioned flexible material 50 of the folding screen means 5 may consist of at least one layer of polyester fabric, for cheaper versions of the retractable roof 1, or of at least one layer of polyamide nylon fabric, also known by the commercial name of Cordura®, for more valuable versions.

In both construction solutions, where two layers of fabric are provided, the aforementioned layer of thermal insulation material can be advantageously placed between them.

In the proposed pop-up roof 1, a front deflector 6 is further provided, associated at the top with the aforementioned roof P of the vehicle V, substantially in contact with it. The front deflector 6 is shaped with an upward extension from the front to the rear area of the same vehicle V, to connect the surface of the same roof P with the front edge of the rigid top 4 when it is arranged in its aforementioned inoperative lowered travel position L.

From the foregoing description, the peculiar characteristics of the pop-up roof in question are particularly evident. Such features are aimed at obtaining a significant improvement in climatic comfort in the additional space under the roof, in particular for the occupants of the bed there located, thus obviating the discomfort, even considerable, that occurs with the known pop-up roofs.

This improvement is largely due to the technical solution of equipping the fixed frame with an air duct, with vents, connected to the vehicle's original air conditioning system, in order to supply the under-roof with air conditioning or simple ventilation air, so that its temperature conditions are substantially the same as those in other parts of the passenger compartment.

On the other hand, the same improvement is due to the construction choices that include layers of heat-insulating material that contribute to reducing the thermal exchange with the outside of the components of the pop-up roof that are larger in area, such as the rigid top and the side curtain.

It is worth mentioning, as an additional benefit, the provision of the front deflector, which makes the pop-up roof aerodynamically efficient on the road, while maintaining the original vehicle's running resistance substantially unchanged, and preventing whistling or hissing noises at higher speeds.

Another advantageous aspect of the proposed pop-up roof is the choice of particularly high-performance materials in terms of lightness, strength, durability and resistance to both sunlight and weather.

It is acknowledged, however, that what is described above is an example and not a limitation, so that any detailed variations in the reinforcing element thus obtained, introduced for technical and/or functional reasons, are considered as of now to fall within the same protective scope defined by the claims below.

1. Pop-up roof for multipurpose vehicles, of the type comprising a fixed frame associated above the vehicle's roof of one of said vehicles and provided with a lever mechanism for moving a rigid top between an inoperative lowered travel position, substantially in line with said vehicle's roof, and a raised operational position, configurable in the parking condition of the same multipurpose vehicle, designed to increase the internal useful height of the latter in the central-rear area, with said pop-up roof also equipped with flexible screen means, extended as a consequence of said raised operating position of the rigid top, suitable for sideway screening the opening created between the latter and said vehicle's roof, wherein said pop-up roof provides means to increase the climatic comfort of the additional internal compartment of said vehicle obtained with said raised operating position of the rigid top, with said means comprising:
said fixed frame applied above said vehicle's roof, so as to edge an opening made in the latter, with the same fixed frame consisting of a hollow structure, defining an annular air duct;
at least one air inlet, provided in said air duct, for the connection of the latter with at least an air supply channel of the air conditioning system of said vehicle;
a plurality of air diffusion vents, distributed along said air duct in the fixed frame, provided for distributing air to said additional compartment under the aforementioned rigid top.

2. Pop-up roof according to claim 1, wherein said means for increasing the climatic comfort of the additional internal compartment of the aforementioned vehicle comprises at least one layer of heat-insulating material associated with said rigid top.

3. Pop-up roof according to claim 1, wherein said hollow structure, defining said fixed frame, consists of at least two elements in thermoformed plastic material assembled together.

4. Pop-up roof according to claim 1, wherein said rigid top is constituted by a shell structure, in which an external layer is made of thermoformed plastic material and an internal layer is made of polycarbonate, and wherein between said external and internal layers, a spacing is defined for housing electric cables and/or for mechanical elements for closing the rigid top and/or for at least one layer of heat-insulating material-.

5. Pop-up roof according to claim 3, wherein said thermoformed plastic material is constituted by a multilayer of ABS and PMMA.

6. Pop-up roof according to claim 1, wherein said air diffusion vents are oriented upwards.

7. Pop-up roof according to claim 1, wherein said screen means interposed between said fixed frame and rigid top are made of flexible material, wherein said means to increase the climatic comfort of the additional internal compartment of the aforementioned vehicle comprises at least a layer of heat-insulating material coupled to said flexible material of the screen means.

8. Pop-up roof according to claim 7, wherein said flexible material consists of at least one layer of polyester fabric.

9. Pop-up roof according to claim 7, wherein said flexible material consists of at least one layer of polyamide nylon thread fabric.

10. Pop-up roof according to claim 1, wherein a front deflector is provided, associated above said roof of the vehicle, substantially in contact with the latter, shaped with an upward trend from the front to the rear of the same vehicle, so as to connect the surface of the same vehicle's roof with the front edge of said rigid top when it is arranged in its aforementioned lowered inoperative position.
